(19) United States
(12) Patent Application Publication
(10) Pub. No.: US 2007/0185912 A1
(43) Pub. Date: Aug. 9, 2007

(54) Off-loading I/O and computationally intensive operations to secondary systems

(75) Inventors: Ajay Kumar Gupta, Fremont, CA (US); Raghupathi Keshava Murthy, Union City, CA (US); Joaquim Anthony Zuzarte, Mountain View, CA (US)

Correspondence Address: INTERNATIONAL BUSINESS MACHINES CORP., IP LAW, 555 BAILEY AVENUE, J46/G4, SAN JOSE, CA, 95141, US

(73) Assignee: International Business Machines Corporation, Armonk, NY (US)

(21) Appl. No.: 11/350,522

(22) Filed: Feb. 8, 2006

(51) Int. Cl. G06F 17/30

(52) U.S. Cl. 707/200

(57) ABSTRACT

Various embodiments of a computer-implemented method, database environment and computer program product are provided which off-load the processing of a database operation. A first database is accessible to a first database server, and a second database is accessible to a second database server. Data is replicated from the first database to the second database, wherein the second database is substantially a copy of the first database. The first database server determines whether to off-load a database operation which would access the first database to the second database server. In response to determining to off-load the database operation, a command is sent to the second database server to perform the database operation. In response to receiving the command, the second database server accesses the second database to perform the database operation. A result of the database operation is received from the second database server.

### BACKGROUND OF THE INVENTION

1.0 Field of the Invention

This invention relates to information processing; and in particular, this invention relates to off-loading input/output (I/O) and computationally intensive operations to secondary systems.

2.0 Description of the Related Art

Database management systems allow data to be accessed quickly and conveniently. The database management system organizes the data. In a relational database management system, data is stored in one or more tables.

FIG. 1 depicts an illustrative table 20. In the table 20, the data is organized into rows 22 and columns 24. A column 24 stores a particular type of data, and the column has a name. For example, in the table 20, the column names are first name 26, last name 28, street address 30, city 32, state 34 and postal code 36; and, the type of data stored in the columns is character data. A row 22 contains particular values of data. In FIG. 1, in the table 20, two exemplary rows 22-1 and 22-2 are illustrated. One or more columns of a table may be used to associate the data in one table with the data in another table. To decrease the amount of time to access data from a table, an index may be provided for the table.

A query language is typically used to access the data in the database. For example, the structured query language (SQL) is one well-known query language. A SQL query can be executed in multiple ways to retrieve specified data. The database management system typically has a query processor which processes the queries. For example, to execute a SQL query, data from multiple tables may be joined. The query processor may execute the SQL query using at least one of multiple join methods, multiple join orders, and multiple access paths. Within the query processor, a query optimizer typically chooses a particular join method, join order and access path to be used to execute the query. Query optimizers in relational database management systems typically use available database statistics to make a cost-based decision to create an optimal plan to execute the query. A database administrator (DBA) typically issues a command to generate and update the database statistics of a column, table or an entire database. The DBA may update the database statistics regularly or when the data or distribution of data changes significantly. To accurately calculate statistics, several actions may be performed. For example, to calculate histogram statistics, a significant portion of the rows in a table are sampled, the sampled data is sorted, and a histogram of the data distribution is created. Each of these actions consumes I/O resources to access the data, typically on a disk drive, and is computationally expensive, that is, consumes a large amount of processor time.

In a production database management system, typically many queries are executed concurrently and a quick response to the queries is desirable. It is undesirable to update database statistics on a production database management system during periods having a heavy query load because any queries which are executing concurrently with the statistics update may be negatively affected, for example, the execution time of the queries may increase. It is difficult to determine how often to update the database statistics. If database statistics are updated too often, the overall performance of the database management system may degrade or resources may be wasted because the statistics may not need to be updated. If database statistics are not updated frequently enough, the optimizer may choose inefficient join methods and access paths for tables because the statistics do not adequately reflect the current state of the data in the database.

The term “cardinality” refers to number of qualified rows from a table for a given set of predicates. The “qualified rows” are those rows which meet the criteria of the set of predicates. The IBM® (Registered trademark of International Business Machines Corporation) DB2® (Registered trademark of International Business Machines Corporation) database management system can monitor an estimated cardinality of a table referenced in a query and compare the estimated cardinality with the actual cardinality of that table. If there is a significant difference between the cardinality estimates and actual cardinalities, the IBM DB2 database management system uses an automated scheduling of the statistics update on the database server associated with the database that contains the table having the significant difference between the estimated and actual cardinality. The database management system schedules a statistics update, that is, a DB2 RUNSTATS command, so that the database statistics will be updated in a maintenance window which is specified by the database administrator.

For tables with a large number of rows, the calculations to update statistics may not complete within the maintenance window. Updating statistics may be computationally intensive. Updating statistics may also be I/O intensive, that is, involve many disk accesses to transfer data from the disk drive to semi-conductor random access memory (RAM) for processing. If the statistics update does not complete within the maintenance window, the database management system will have to wait for the next maintenance window to continue the statistics calculation. Until the statistics update completes, queries may not be executed in a most efficient manner. Therefore, there is a need for an improved technique to update statistics.

Database operations other than updating statistics may also be computationally intensive and/or I/O intensive, and may negatively affect database performance. Therefore there is a need for an improved technique to perform other database operations, in addition to updating statistics.

### SUMMARY OF THE INVENTION

To overcome the limitations in the prior art described above, and to overcome other limitations that will become apparent upon reading and understanding the present specification, various embodiments of a computer-implemented method, database environment and computer program product are provided which off-load the processing of a database operation.

In various embodiments, a first database is accessible to a first database server, and a second database is accessible to a second database server. Data is replicated from the first database to the second database, wherein the second database is substantially a copy of the first database. The first database server determines whether to off-load a database operation which would access the first database to the second database server. In response to determining to off-load the database operation, a command is sent to the second database server to perform the database operation. A result of the database operation is received from the second database server.

In other embodiments, a computer program product comprises a computer usable medium having computer usable program code for operating a database in a database environment comprising a first database accessible to a first database server, and a second database accessible to a second database server, wherein the second database is substantially a copy of the first database. The computer program product includes computer usable program code for determining, by the first database server, whether to off-load a database operation which would access the first database to the second database server. The computer program product includes computer usable program code for, in response to determining to off-load the database operation, sending a command to the second database server to perform the database operation. The computer program product includes computer usable program code for receiving a result of the database operation from the second database server.

In yet other embodiments, a database environment comprises a first database accessible to a first database server, and one or more secondary databases accessible to one or more secondary database servers, respectively. The database environment further comprises data that is replicated from the first database to the one or more secondary databases, wherein the one or more secondary databases are substantially a copy of the first database; a database operation which, if performed at the first database server, would access the first database; a command from the first database server to one secondary database server of the secondary database servers to perform the database operation; and a result, at the first database server, of the database operation from the one secondary database server

In this way, various embodiments are provided which off-load the processing of a database operation from one database server to another database server.

### BRIEF DESCRIPTION OF THE DRAWINGS

The teachings of the present invention can be readily understood by considering the following description in conjunction with the accompanying drawings, in which:

FIG. 1 depicts an illustrative table;

FIG. 2 depicts an illustrative database environment;

FIG. 3 depicts a flowchart of an embodiment of off-loading the processing of a command to update database statistics in the illustrative database environment of FIG. 2;

FIG. 4 depicts a flowchart of another embodiment of off-loading the processing of a database operation in the illustrative database environment of FIG. 2;

FIG. 5 depicts another illustrative database environment having a cascaded configuration, in which the processing of a database operation is off-loaded;

FIG. 6 depicts yet another illustrative database environment in a star configuration, in which the processing of a database operation is off-loaded;

FIG. 7 depicts an illustrative data processing system which uses various embodiments of the present invention; and

FIG. 8 depicts various components of the database management system.

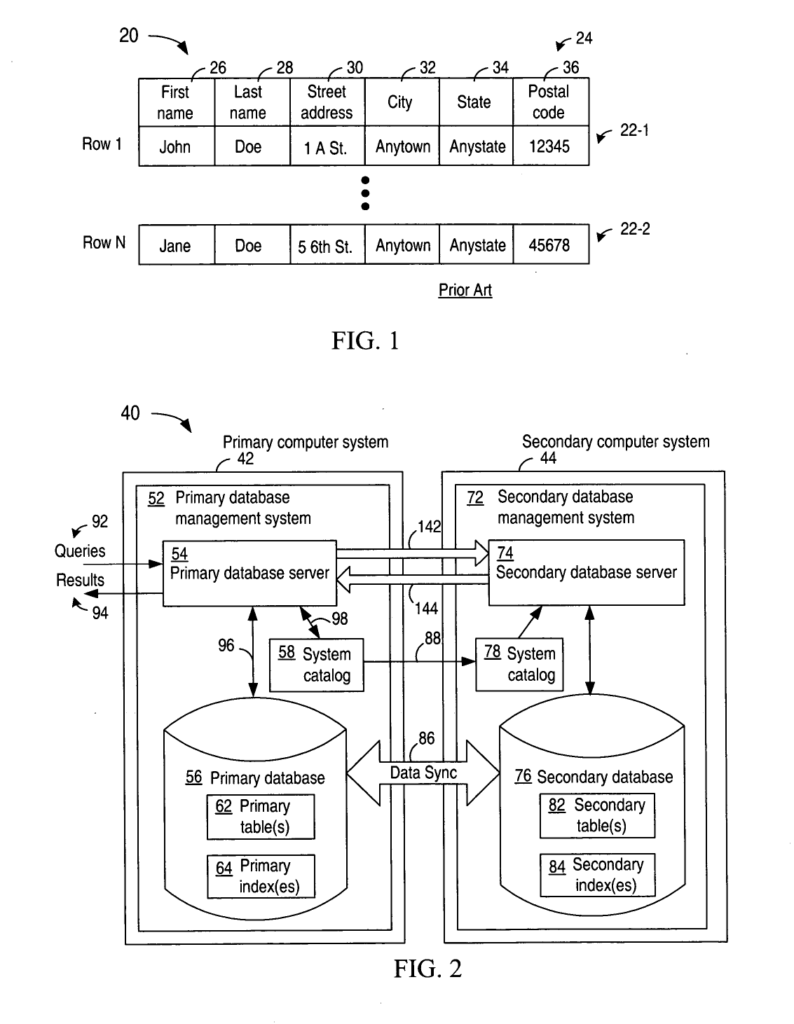

To facilitate understanding, identical reference numerals have been used, where possible, to designate identical elements that are common to some of the figures.

### DETAILED DESCRIPTION

After considering the following description, those skilled in the art will clearly realize that the teachings of the various embodiments of the present invention can be utilized to improve performance of a database management system. Various embodiments of a computer-implemented method, database environment and computer program product are provided which off-load the processing of a database operation.

In various embodiments, a first database is accessible to a first database server, and a second database is accessible to a second database server. Data is replicated from the first database to the second database, wherein the second database is substantially a copy of the first database. The first database server determines whether to off-load a database operation which would access the first database, to the second database server. In response to determining to off-load the database operation, a command is sent to the second database server to perform the database operation. In response to receiving the command, the second database server accesses the second database to perform the database operation. A result of the database operation is received from the second database server. In various embodiments, the primary database server saves, and in some embodiments, processes the result.

In other embodiments, a computer program product comprises a computer usable medium having computer usable program code for operating a database in a database environment comprising a first database accessible to a first database server, and a second database accessible to a second database server, wherein the second database is substantially a copy of the first database. The computer program product includes computer usable program code for determining, by the first database server, whether to off-load a database operation which would access the first database to the second database server. The computer program product includes computer usable program code for, in response to determining to off-load the database operation, sending a command to the second database server to perform the database operation. The computer program product includes computer usable program code for receiving a result of the database operation from the second database server.

In yet other embodiments, a database environment comprises a first database accessible to a first database server, and one or more secondary databases accessible to one or more secondary database servers, respectively. The database environment further comprises data that is replicated from the first database to the one or more secondary databases, wherein the one or more secondary databases are substantially a copy of the first database; a database operation which, if performed at the first database server, would access the first database; a command from the first database server to one of the secondary database servers to perform the database operation; and a result, at the first database server, of the database operation from the one secondary database server.

FIG. 2 depicts an illustrative database environment 40 comprising a primary computer system 42 and a secondary computer system 44. The primary computer system 42 comprises a primary database management system 52 which comprises a primary database server 54, a primary database 56 and a system catalog 58. The primary database 56 comprises one or more primary tables 62 and zero or more primary indexes 64. The system catalog 58 comprises database statistics. In some embodiments, the primary database management system 52 is the IBM Informix® (Registered trademark of International Business Machines Corporation) Dynamic Server; however, in other embodiments, other database management systems may be used.

In the secondary computer system 44, a secondary database management system 72 comprises a secondary database server 74, a secondary database 76 and a copy of the system catalog 78. The secondary database 76 comprises one or more secondary tables 82 and zero or more secondary indexes 84. The secondary tables 82 and indexes 84 of the secondary database 74 have the same structure as the primary tables 62 and indexes 64 of the primary database 54. Data is replicated from the primary tables 62 and indexes 64 of the primary database 54 to the secondary tables 82 and indexes 84 of the secondary database 74. In various embodiments, a Data Sync operation 86 is used to replicate the data from the primary database 54 to the secondary database 74. The system catalog 78 in the secondary database management system 72 contains database statistics and is updated, as indicated by arrow 88, based on the data in the system catalog 58 of the primary database management system 52, in some embodiments, using log relay and replay. In some embodiments, the secondary database management system 72 is the IBM Informix Dynamic Server; however, in other embodiments, other database management systems may be used.

To achieve high reliability, the secondary database management system 72 provides a “hot backup” of the primary database management system 52. A hot backup is a backup which is performed on data even though that data is actively accessible to users and may be being updated. If the primary database management system 52 fails, the secondary database management system 72 can quickly be used instead of the primary database management system 52. To provide a hot backup, data from the primary database 56 is replicated to the secondary database 76 while an application is reading data from and writing data to the primary database 56. In some embodiments, the secondary database management system 72 is a duplicate of the primary database management system 52,

The primary database server 54 processes queries 92 which are typically from the application. In response to a query, the primary database server 54 reads data from and/or writes data to, as indicated by arrow 96, one or more primary tables 62 of the primary database 56. To process a query, the primary database server 54 accesses the system catalog 58 of the primary database management system 52 as indicated by arrow 98. The primary database server 54 typically returns a query result 94 to the application in response to the query.

Various embodiments of the present invention exploit available computing power in the secondary computer system 44, and the secondary database 76 which is a copy of the primary database 56. In various embodiments, while the primary database server 54 executes the queries, the secondary database server 74 calculates updated database statistics based on the data in the secondary database 76, and those updated database statistics are used to keep the database statistics in the system catalog 58 in the primary database management system 52 up-to-date.

In various embodiments, the data of the primary database 56 is replicated to the secondary database 76, and may not exactly match the data in the primary database 56 at all times, that is, the data in the secondary database 76 is substantially a copy of the data in the primary database 56. In some embodiments, the data in the secondary database 76 is exactly the same as the data in the primary database 56.

In some embodiments, the data in the secondary database 76 is a read-only copy of the data in the primary database 56. In these embodiments, the secondary database server 74 will only allow data to be read from the secondary database 76; and, an application associated with the read-only hot backup can read data from the secondary database 76.

In other embodiments, the data in the secondary database 76 is not a read-only copy of the data in the primary database 56. In some embodiments, the data in the secondary database 76 is not significantly different from the data in the primary database 56 and database statistics computed using that data in the secondary database 76 would not degrade performance. In some embodiments, the data in the secondary database 76 is not exactly the same as the data in the primary database 56 and does not contain uncommitted data. For example, the data in the secondary database 76 may be up to three minutes behind the data in the primary database 56, and database statistics that would improve the performance of the primary database server 54 may be calculated based on the data in the secondary database 76. Whether data in the secondary database will provide database statistics which will improve the performance of the primary database server 54 depends on the volume and magnitude of the mismatch between the data in the primary and secondary databases, 56 and 76, respectively.

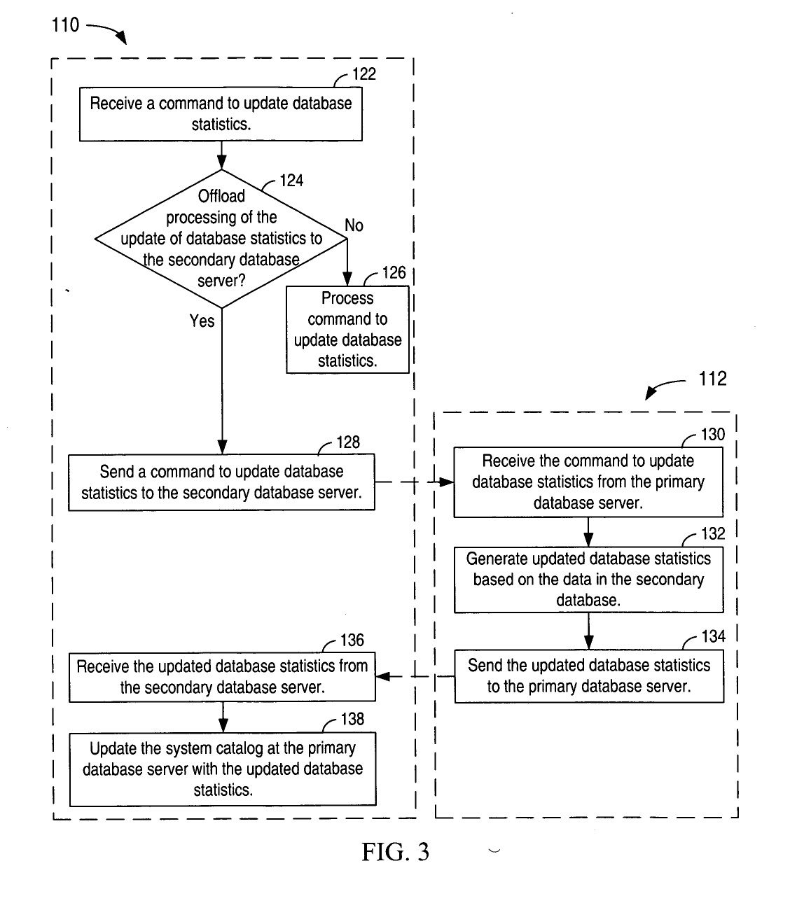

FIG. 3 depicts a flowchart of an embodiment of off-loading the processing of a command to update database statistics in the illustrative database environment 40 of FIG. 2. In FIG. 3, the steps in block 110 are performed by the primary database server 54 (FIG. 2), and the steps in block 112 are performed by the secondary database server 74 (FIG. 2).

In step 122, the primary database server receives a command to update database statistics. In step 124, the primary database server determines whether to off-load the processing of the update of database statistics to the secondary database server. In response to, in step 124, the primary database server determining not to off-load, in step 126 the primary database server processes the command to update database statistics.

In response to, in step 124, the primary database server determining to off-load the processing of the update of database statistics, in step 128, the primary database server sends a command to update database statistics to the secondary database server, indicated by arrow 142 of FIG. 2.

In step 130, the secondary database server receives the command to update database statistics from the primary database server. In step 132, the secondary database server generates updated database statistics based on the data in the secondary database. In some embodiments, the secondary database server determines the percentage of rows of one or more tables to sample, reads the rows, and calculates the statistics. The database statistics calculation may comprise sorting the sampled data, determining duplicates, generating histograms, and calculating distributions.

In step 134, the secondary database server sends the updated database statistics to the primary database server, as indicated by arrow 144 of FIG. 2. In step 136, the primary database server receives the updated database statistics. In step 138, the primary database server updates the system catalog at the primary database server with the updated database statistics. In various embodiments, the primary database server writes the updated database statistics to the system catalog.

Once the updated database statistics are written to the system catalog at the primary database server, the updated database statistics are propagated to the system catalog of the secondary database management system. In various embodiments, the database management system log relay and replay mechanism is used to replicate the updated database statistics to the system catalog of the secondary database management system. In other embodiments in which the secondary database is not read-only and is updateable, the secondary database server may write the updated database statistics to its system catalog rather than using a log relay and replay mechanism.

In this way, by calculating the updated database statistics using the secondary database server on the secondary computer system and sending the updated database statistics to the primary database server, the query processing of the primary database server is not affected and the query optimizer of the primary database server will be able to use up-to-date statistics and choose better query execution plans.

Various embodiments of step 124 will be explained in further detail. In step 124, the primary database server determines whether to off-load the processing of the updating of database statistics to the secondary database server. In some embodiments, the primary database server's decision to off-load is load-based. In response to the load of the primary database server exceeding a predetermined threshold for that load, the primary database server determines that the database operation of updating statistics will be off-loaded. For example, a load may be a number of queries concurrently executing in the database management system, a number users connected to the database management system, a sum of the cost of all the queries executing in the database management system, an I/O response time or CPU utilization of the computer system.

In other embodiments, the primary database server's decision to off-load is rule-based. The primary database server determines that the processing of the updating of statistics is off-loaded if it is determined to be computationally and/or I/O expensive. The primary database server determines a number of tables, columns, and rows to be sampled, and estimates a cost, such as the computational or I/O, based on the number of tables, columns and rows to be sampled. In response to the cost exceeding a predetermined threshold, the database management system will off-load the processing of the updating of database statistics.

In various embodiments, the primary database server determines whether the processing of database operations other than the updating of database statistics will be off-loaded. In another embodiment, the secondary database server can provide read-only access to the data of the secondary database to permit the client load to be balanced between the primary and secondary database servers. In some embodiments, the primary database server may off-load sampling queries. In various embodiments, the primary database server may off-load certain aggregate functions such as computing an average, or median.

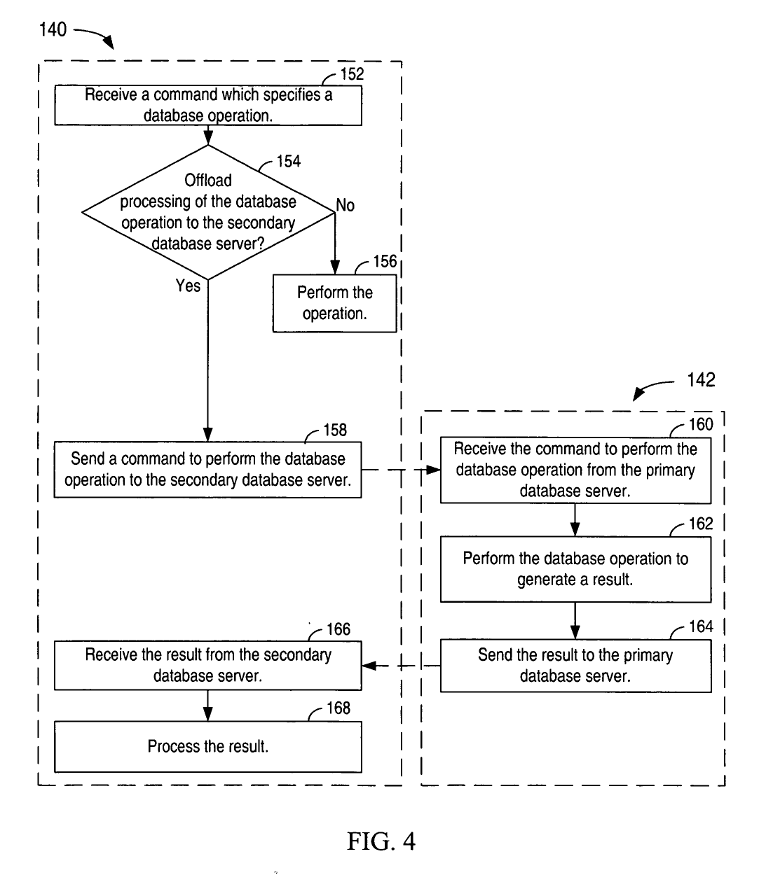

FIG. 4 depicts a flowchart of another embodiment of off-loading the processing of a database operation in the illustrative database environment of FIG. 2. In FIG. 4, database operations other than updating statistics may also be off-loaded. In FIG. 4, the steps in block 140 are performed by the primary database server 54 (FIG. 2), and the steps in block 142 are performed by the secondary database server 74 (FIG. 2).

In step 152, the primary database server receives a command which specifies a database operation. In various embodiments, the database operation, if performed by the primary database server, would access the primary database.

In step 154, the primary database server determines whether to off-load the processing of the database operation to the secondary database server. In some embodiments, in determining whether to off-load a database operation, the primary database server considers various criteria. If the database operation is computationally and/or I/O expensive, and does not need the latest data, the primary database server may off-load that operation to be performed by the secondary system. The data in the secondary database server may be different from the data in the primary database server, for example, lag behind the data in the primary database server by a predetermined amount of time. If the database operation needs the latest and most accurate data, the primary database server will determine not to off-load that database operation. In addition, the primary database server also determines whether the database operation to off-load will involve a large amount of data transfer which will negate the advantages of off-loading. For example, off-loading a database operation may cause a large amount of data, such as table data, to be sent from the primary database server to the secondary database server. If off-loading the database operation would cause a large amount of data to be transferred, the primary database server will not off-load that database operation. For example, the primary database server determines that a large amount of data will be transferred, if the amount of data to be transferred exceeds a predetermined data-transfer threshold. The primary database server also determines whether the database operation to off-load will not affect the execution of concurrent queries or transactions in the primary database server. If so, the primary database server will not off-load that database operation.

In response to, in step 154, the primary database server determining not to off-load, in step 156 the primary database server performs the database operation.

In response to, in step 154, the primary database server determining to off-load the processing of the database operation, in step 158, the primary database server sends a command to perform the database operation the secondary database server.

In step 160, the secondary database server receives the command to perform the database operation from the primary database server. In step 162, the secondary database server performs the database operation to generate a result. In various embodiments, the database operation is based on the data in the secondary database.

In step 164, the secondary database server sends the result to the primary database server. In step 166, the primary database server receives the result from the secondary database server. In step 168, the primary database server processes the result. Depending on the database operation, the result may be returned to an application as part of a response to a query, the result may be used internally in the primary database management system, or the result may be stored.

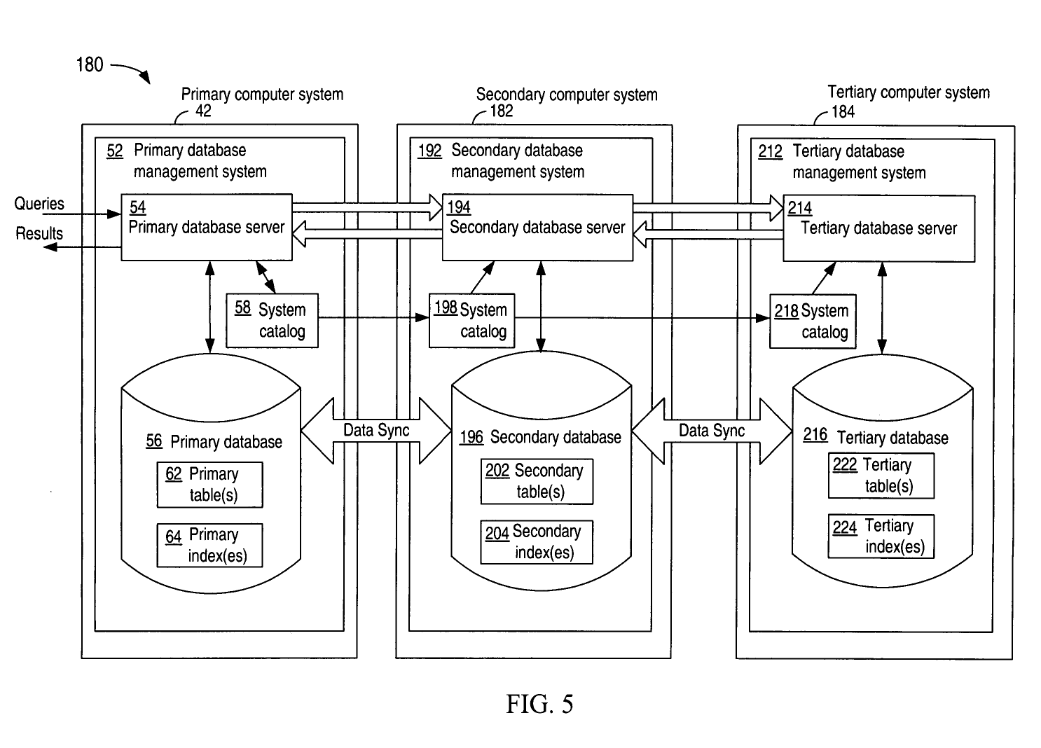

FIG. 5 depicts another illustrative database environment 180 having a cascaded configuration, in which the processing of a database operation is off-loaded. The illustrative database environment 180 comprises a primary computer system 42, a secondary computer system 182 and a tertiary computer system 184, in which processing is off-loaded to the tertiary computer system 184. The primary computer system 42 comprises a primary database management system 52 which comprises a primary database server 54, a primary database 56 and a system catalog 58. The primary database 56 comprises one or more primary tables 62 and zero or more primary indexes 64.

The secondary computer system 182 comprises a secondary database management system 192 which comprises a secondary database server 194, a secondary database 196 and a copy of the system catalog 198. The secondary database 196 comprises one or more secondary tables 202 and zero or more secondary indexes 204.

The tertiary computer system 184 comprises a tertiary database management system 212 which comprises a tertiary database server 214, a tertiary database 216 and a copy of the system catalog 218. The tertiary database 216 comprises one or more tertiary tables 222 and zero or more tertiary indexes 224.

The secondary database management system 192 is a hot backup of the primary database management system 52; and the tertiary database management system 214 is a hot backup of the secondary database management system 192. Data is replicated from the primary database 56 to the secondary database 196; and data from the secondary database 196 is replicated to the tertiary database 216. In this embodiment, the secondary database server 194 can off-load the processing of updating database statistics or another database operation to the tertiary database server 214. In some embodiments, the secondary database server 194 performs steps 122-128, and 136 of block 110 of FIG. 3, and the tertiary database server 214 performs steps 130-134 of block 112 of FIG. 3. In this embodiment, in response to receiving updated database statistics from the tertiary database server 214, the secondary database server 194 sends the updated database statistics from the tertiary database server 214 to the primary database server 52 which updates the system catalog with the updated database statistics. The updated database statistics in the system catalog are propagated from the primary database management system 52 to the secondary and tertiary database management systems, 192 and 212, respectively.

In another embodiment, the secondary database server 194 performs steps 152-158, and 166 of block 140 of FIG. 4, and the tertiary database server 214 performs steps 160-164 of block 142 of FIG. 4. In this embodiment, in response to receiving the result from the tertiary database server 214, the secondary database server 194 sends the result from the tertiary database server 214 to the primary database server 52 which processes the result of the off-loaded database operation.

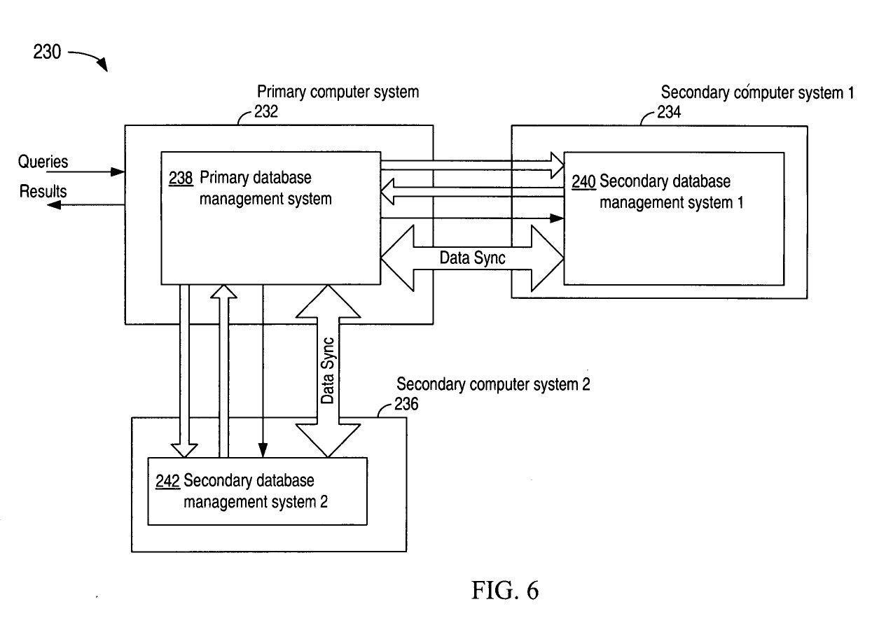

FIG. 6 depicts yet another illustrative database environment 230 in a star configuration, in which the processing of a database operation is off-loaded. The illustrative database environment 230 comprises a primary computer system 232 and multiple secondary computer systems 234 and 236. The primary computer system 232 comprises a primary database management system 238. In various embodiments, the primary database management system 238 is the primary database management system 52 of FIG. 2. Secondary computer system 1 234 comprises secondary database management system 1 240. Secondary computer system 236 comprises secondary database management system 2 242. The primary database management system 232 receives queries and provides results.

Secondary database management systems 240 and 242 are the same as secondary database management system 72 of FIG. 2. Data is replicated from the primary tables and indexes of the primary database to the secondary tables and indexes of the secondary databases. In various embodiments, a Data Sync operation is used to replicate the data from the primary database to the secondary database. The system catalog of the secondary database management systems 240 and 242 is updated based on the system catalog of the primary database management system 238.

In this embodiment, the primary database server performs the flowchart of block 110 of FIG. 3 or block 140 of FIG. 4. However, prior to step 128 of FIG. 3 or step 158 of FIG. 4, the primary database management system 238 selects a secondary database server to which the primary database server will send the command to perform the database operation.

In some embodiments, the database environment 230 comprises more than two secondary computer systems and secondary database management systems.

In various embodiments, a database environment comprises both the cascaded configuration of FIG. 5 and the star configuration of FIG. 6. In this database environment, the primary database management system has a plurality of secondary database management systems which provide a hot backup, and at least one of the secondary database management systems is coupled to a tertiary database management system which provides a hot backup of the secondary database management system.

Various embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, various embodiments of the invention can take the form of a computer program product accessible from a computer usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and digital video disk (DVD).

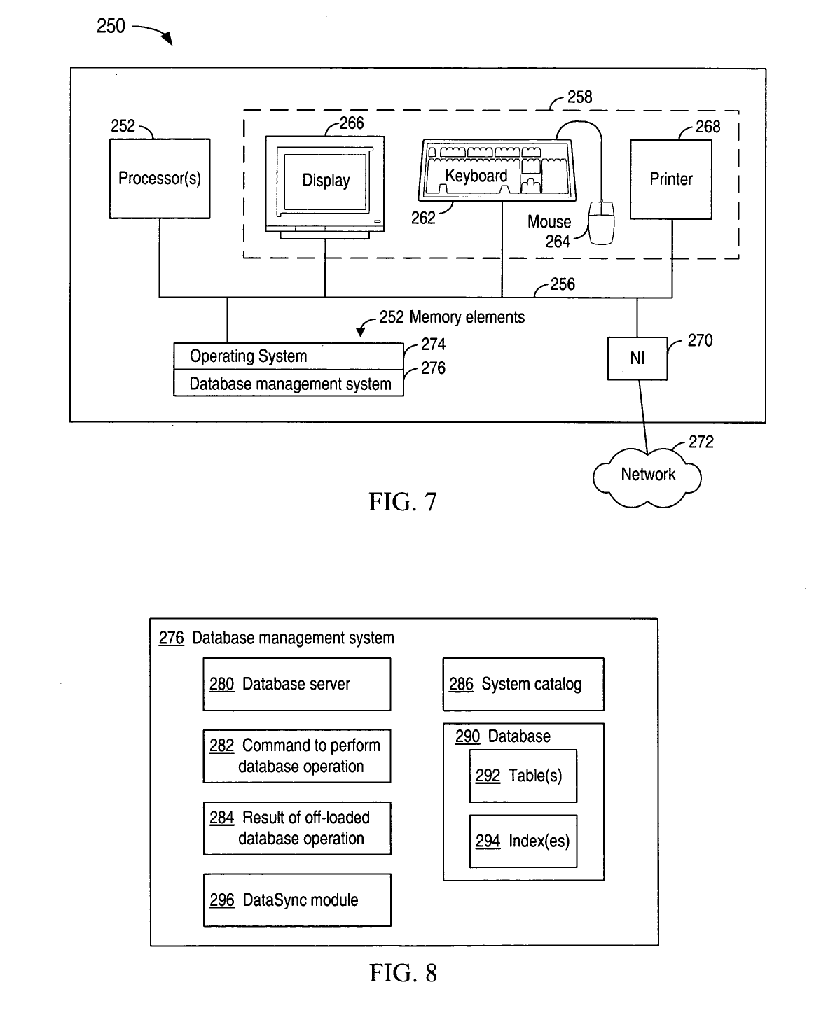

FIG. 7 depicts an illustrative data processing system 250 which uses various embodiments of the present invention. The data processing system 250 suitable for storing and/or executing program code will include at least one processor 252 coupled directly or indirectly to memory elements 254 through a system bus 256. The memory elements 254 can include local memory employed during actual execution of the program code, bulk storage, and cache memories which provide temporary storage of at least some program code in order to reduce the number of times code must be retrieved from bulk storage during execution.

Input/output or I/O devices 258 (including but not limited to, for example, a keyboard 262, pointing device such as a mouse 264, a display 266, printer 268, etc.) can be coupled to the system bus 256 either directly or through intervening I/O controllers.

Network adapters, such as a network interface (NI) 270, may also be coupled to the system bus 256 to enable the data processing system to become coupled to other data processing systems or remote printers or storage devices through intervening private or public networks 272. Modems, cable modem and Ethernet cards are just a few of the currently available types of network adapters. The network adapter may be coupled to the network via a network transmission line, for example twisted pair, coaxial cable or fiber optic cable, or a wireless interface that uses a wireless transmission medium. In addition, the software in which various embodiments are implemented may be accessible through the transmission medium, for example, from a server over the network.

The memory elements 252 store an operating system 274 and a database management system 276.

The operating system 274 may be implemented by any conventional operating system such as z/OS® (Registered Trademark of International Business Machines Corporation), MVS® (Registered Trademark of International Business Machines Corporation), OS/390® (Registered Trademark of International Business Machines Corporation), AIX® (Registered Trademark of International Business Machines Corporation), UNIX® (UNIX is a registered trademark of the Open Group in the United States and other countries), WINDOWS® (Registered Trademark of Microsoft Corporation), LINUX® (Registered trademark of Linus Torvalds), Solaris® (Registered trademark of Sun Microsystems Inc.) and HP-UX® (Registered trademark of Hewlett-Packard Development Company, L.P.).

FIG. 8 depicts various components of the database management system 276 of FIG. 7. Referring to both FIGS. 7 and 8, the database management system 276 comprises a database server 280, a command to perform a database operation 282, a result of the off-loaded database operation 284, a system catalog 286, a database 290 comprising table(s) 292 and index(es) 294, and a DataSync module 296 that performs the Data Sync operation. For example, the command to perform a database operation 282 may be to gather database statistics, and the result of the off-loaded database operation 284 comprises database statistics, for example, cardinality, frequency or histogram statistics. In another example, the command to perform a database operation 282 may be to perform a sampling query, and the result of the off-loaded database operation 284 is the result of executing the sampling query. In yet another example, the command to perform a database operation 282 may be to perform an aggregate function, for example, an average, median, mean or variance of a subset of data in a table, and the result of the off-loaded database operation 284 comprises the result of the aggregate function, such as the average, median, mean or variance of that subset of data, respectively.

In some embodiments, the data processing system 250 implements the primary computer system 52 of FIG. 2; and, the database management system 276, the database server 280, system catalog 286 and database 290 are the primary database management system 42 of FIG. 2, the primary database server 54 of FIG. 2, the system catalog 58 of FIG. 2 and primary database 56 of FIG. 2, respectively. In this embodiment, the database server 280 generates and sends the command to perform the database operation 282 to a secondary database server, and receives the result of the off-loaded database operation 284 from the secondary database server.

In other embodiments, the data processing system 250 implements the secondary computer system 44 of FIG. 2; and, the database management system 276, the database server 280, system catalog 286 and database 290 are the secondary database management system 72 of FIG. 2 the secondary database server 74 of FIG. 2, the system catalog 78 of FIG. 2 and secondary database 76 of FIG. 2, respectively. In this embodiment, the database server 280 receives and processes the command to perform the database operation 282, generates the result of the off-loaded database operation 284 using the secondary database 290, and returns the result of the off-loaded database operation 284 to the primary database server. Alternately, the database server 280 receives the command to perform the database operation 282, sends that command 282 to a tertiary database server, receives the result of the off-loaded database operation 284 from the tertiary database server, and then returns the result of the off-loaded database operation 284 to the primary database server. In another alternate embodiment, the database server 280 receives the command to perform the database operation 282, generates and sends another command to perform the database operation to a tertiary database server, receives the result of the off-loaded database operation 284 from the tertiary database server, and then returns the result of the off-loaded database operation 284 to the primary database server.

In various embodiments, the data processing system 250 implements the secondary computer system 182 of FIG. 5 and the database management system 276 is the secondary database management system 192 of FIG. 5.

In yet other embodiments, the data processing system 250 implements the tertiary computer system 184 of FIG. 5 and the database management system 276 is the tertiary database management system 212 of FIG. 5.

In some embodiments, the data processing system 250 implements the primary computer system 232 of FIG. 6 and the database management system 276 is the primary database management system 238 of FIG. 6. In other embodiments, the data processing system 250 implements one of the secondary computer systems 234 and 236 of FIG. 6 and the database management system 276 is one of the secondary database management systems 240 and 242, respectively, of FIG. 6.

The exemplary data processing system 250 illustrated in FIG. 7 is not intended to limit the present invention. Other alternative hardware environments may be used without departing from the scope of the present invention.

The foregoing detailed description of various embodiments of the invention has been presented for the purposes of illustration and description. It is not intended to be exhaustive or to limit the invention to the precise form disclosed. Many modifications and variations are possible in light of the above teachings. It is intended that the scope of the invention be limited not by this detailed description, but rather by the claims appended thereto.

What is claimed is:

1. A computer-implemented method, a first database being accessible to a first database server, and a second database being accessible to a second database server, comprising:
replicating data from said first database to said second database, wherein said second database is substantially a copy of said first database;
determining, by said first database server, whether to off-load a database operation which would access said first database to said second database server;
in response to determining to off-load said database operation, sending a command to said second database server to perform said database operation; and
receiving a result of said database operation from said second database server.

2. The method of claim 1, further comprising:
in response to receiving said command, accessing, by said second database server, said second database to perform said database operation; and
sending, by said second database server, said result of said database operation to said first database server.

3. The method of claim 1 wherein said second database is read-only.

4. The method of claim 1 wherein said database operation is to update database statistics.

5. The method of claim 4 wherein said result comprises updated database statistics, and further comprising:
updating, by said first database server, a first system catalog associated with said first database server with said updated database statistics; and
propagating said updated database statistics from said first system catalog associated with said first database server to a second system catalog associated with said second database server.

6. The method of claim 1 wherein said determining, by said first database server, whether to off-load said database operation is rule-based.

7. The method of claim 1 wherein said determining, by said first database server, whether to off-load said database operation is load-based.

8. A computer program product comprising a computer usable medium having computer usable program code for operating a database in a database environment comprising a first database accessible to a first database server, and a second database accessible to a second database server, wherein said second database is substantially a copy of said first database, said computer program product including:
computer usable program code for determining, by said first database server, whether to off-load a database operation which would access said first database to said second database server;
computer usable program code for, in response to determining to off-load said database operation, sending a command to said second database server to perform said database operation; and
computer usable program code for receiving a result of said database operation from said second database server.

9. The computer program product of claim 8 further comprising:
computer usable program code for receiving said command by said second database server; and in response to receiving said command, causing said database operation to be performed by said second database server, wherein said database operation accesses said second database.

10. The computer program product of claim 8 wherein said second database is read-only.

11. The computer program product of claim 8 wherein said database operation is to update database statistics.

12. The computer program product of claim 11 wherein said result comprises updated database statistics, and further comprising:
computer usable program code for updating, by said first database server, a first system catalog associated with said first database server with said updated database statistics; and
computer usable program code for propagating said updated database statistics from said first system catalog associated with said first database server to a second system catalog associated with said second database server.

13. The computer program product of claim 8 wherein said computer usable program code for determining, by said first database server, whether to off-load said database operation is rule-based.

14. The computer program product of claim 8 wherein said computer usable program code for determining, by said first database server, whether to off-load said database operation is load-based.

15. A database environment, comprising:
a first database accessible to a first database server;
one or more secondary databases accessible to one or more secondary database servers, respectively;
data that is replicated from said first database to said one or more secondary databases, wherein said one or more secondary databases are substantially a copy of said first database;
a database operation which, if performed at said first database server, would access said first database;
a command from said first database server to one secondary database server of said secondary database servers to perform said database operation; and
a result, at said first database server, of said database operation from said one secondary database server.

16. The database environment of claim 15 further comprising:
at least one tertiary database accessible to at least one tertiary database server, respectively;
data that is replicated from said one of said secondary databases to said at least one tertiary database;
a command from said one secondary database server to said tertiary database server to perform said database operation; and
said result of said database operation from said tertiary database server, at said one secondary database server.

17. The database environment of claim 16 wherein said one or more secondary databases are read-only and said tertiary database is read-only.

18. The database environment of claim 15 wherein said one or more secondary database servers provide a hot backup of said primary database server.

19. The database environment of claim 15 wherein said one or more secondary databases are read-only.

20. The database environment of claim 15 wherein said database operation is to update database statistics.
